(19) United States
(12) Patent Application Publication
(10) Pub. No.: US 2014/0265002 A1
(43) Pub. Date: Sep. 18, 2014

(54) CELLULOSIC MICROPOWDER PRODUCTION SYSTEM

(71) Applicant: BIOMASS CONVERSIONS, LLC, (US)

(72) Inventor: Seiji HATA, Tokyo (JP)

(73) Assignee: BIOMASS CONVERSIONS, LLC, Palos Verdes Estates, CA (US)

(21) Appl. No.: 13/839,472

(22) Filed: Mar. 15, 2013

(51) Int. Cl. B29B 9/00

(52) U.S. Cl. CPC B29B 9/00
USPC 264/140

(57) ABSTRACT

An improved process is provided for reducing cellulosic biomass into air suspendable micropowder. Although the process is particularly suitable for processing empty fruit bunches of oil palms, it is adaptable to most cellulosic biomass. The incoming biomass has a water content of around 50% and is reduced to centimeter scale pieces by a chipper or similar device. These pieces are then processed by a tandem line of four pairs of grooved rollers each successive roller having a larger number of grooves. This process squeezes moisture from the biomass and reduces the material into millimeter scale pieces. After an optional drying stage, the material is fed into a terrace line of three or four essentially smooth rollers which squash the material and reduce the particle size into a micrometer scale. Finally, the material is suspended in an air stream and fractionated by a cyclone and bag filter system.

### BACKGROUND OF THE INVENTION

1. Area of the Art

The present invention is in the art of energy production and is directed towards a process for converting biomass into a micropowder that can either be readily hydrolyzed into sugars or can be readily burned as a fuel to release heat.

2. Description of the Background Art

The worldwide problems with energy are well known. Modern civilization depends on technology that consumes an inordinate amount of energy. The is a great consumption of energy for manufacture, for transportation and for heating and cooling as well as lighting our homes and places of work. Large amounts of energy are also consumed in the production of our food in the manufacture of fertilizer and agricultural chemicals and in powering machinery necessary for growing and harvesting crops. Currently the majority of the human population does not have access to this energy intensive technology; yet the present rate of energy consumption is already outstripping supplies and leading to significant climate change from carbon dioxide release. As a larger and larger proportion of the rapidly growing world population adopts energy intensive technology, this problem can only get worse.

The vast majority of energy currently consumed by our technology is solar energy captured by photosynthetic plants. Photosynthesis converts light energy from the sun into chemical energy stored in carbohydrates. During this process water molecule are split to release oxygen and the hydrogen atoms are combined with carbon dioxide taken from the atmosphere to synthesize (by a process known as carbon fixation) carbohydrates. A portion of this captured solar energy is energy captured by recently living plants, but the majority of this energy was captured long ago by plants that have long been dead—so called fossil fuels. When fuel is burned, oxygen from the atmosphere combines with the fuel molecules to release the stored energy as well as water and carbon dioxide. So if fuel from contemporary plants is burned, the carbon dioxide that was recently fixed is returned to the atmosphere without any significant net change in the level of atmospheric carbon dioxide. However, when fossil fuels are burned, carbon dioxide that has been out of circulation for millions of years is released. There are not enough living plants to fix this surfeit of carbon dioxide so the level of carbon dioxide in the atmosphere steadily increases. This alters the temperature of the atmosphere as well as the pH of the oceans with as yet unknown long-term effects on climate and marine life. At the very least these changes are disruptive, if not outright catastrophic. The only rational response to this problem is to attempt to slow and ultimately reverse the increase in atmospheric carbon dioxide.

Because we are unlikely to abandon our technology and because we do not yet have safe technologies to replace carbon-based fuels, it seems that we need to decrease or even ban the use of fossil fuel and develop global energy systems that depend on fixed carbon from contemporary photosynthesis. At this time most of the energy consumed is either in the form of motor fuel to power transportation and other portable mechanisms and electricity to power stationary uses such as lighting, heating, cooling and manufacturing as well as a growing amount of transportation. There have been some recent attempts to ferment foods (such as maize) into ethanol for use as a motor fuel. However, this has generally had a disastrous effect on food prices and may not even be carbon dioxide neutral due to the large input of fossil fuels required to grow maize. Because photosynthetic plants construct their bodies from carbohydrates (primarily cellulose), biomass (plant bodies) would appear to offer a better energy source than fermentation of food products. Traditionally, biomass (e.g. wood) was burned to power steam engines, but that use is neither convenient nor particularly efficient. In theory, cellulose can be hydrolyzed into fermentable sugars; however, an efficient conversion process has proven elusive.

For biomass resources to satisfy our energy needs, biomass needs to be converted to electricity and to ethanol (or some other comparable liquid fuel). The present inventor has long been concerned with converting raw biomass into a readily hydrolyzable form. He has demonstrated two different mechanical systems for reducing cellulosic biomass into micropowder that can be efficiently hydrolyzed by currently available enzymes. The inventor has demonstrated that improved hydrolysis is partly a result of mechanical disruption of the enzymatically resistant “paracrystalline” regions of cellulose in the plant cell wall to create cellulosic micropowder. More recently the inventor has developed a chemo-mechanical process for rapidly and efficiently breaking down paracrystalline cellulose so as to greatly potentiate enzymatic hydrolysis. Also, the inventor demonstrated that cellulosic micropowder can be directly burned to provide a convenient heat source for generation of electricity. Thus, we now have the means to convert cellulosic biomass into both electricity and liquid fuel. However, the methods of mechanical generation of micropowder henceforth disclosed are too slow and consume too much energy to efficiently meet our energy needs. Now the inventor discloses a large scale, energy efficient system for converting cellulosic biomass into micropowder. The micropowder produced is ideal for either mechano-chemical conditioning into a readily hydrolyzable form of for direct combustion for generation of electricity.

Fossil fuels are attractive because they are “energy dense” containing high levels of energy per unit weight. Plus fossil fuels are readily available in large amounts—thousands of tons per day. Biomass production is related to the area given over to photosynthesis. In temperate climates biomass production is in the region of five tons per hectare; in tropical regions biomass production of 25 tons per hectare is not unreasonable. If one calculates the annual biomass production per year for a 20 km square area (400 km²=40,000 ha), assuming a production of 10 tons per hectare, the total production of this area is 400,000 tons per year. This is an amount optimal for transportation of the biomass feedstock to a dedicated factory. If the factory has a capacity of 400,000 tons per year, the factory has a daily capacity of around 1300 tons. Therefore, we can calculate the operation line's capacity for this factory. Although an energy facility operates “24/7” in actual fact every part of the factory cannot operate non-stop because of need for maintenance, etc. Depending on how many days per year and how many hours per day the factory is operational a 60-120 ton per hour capacity is needed. If we use 10 processing lines to achieve this capacity, each line requires the capacity to process 6-10 ton per hour. This then is our target for technology and equipment design.

Although a capacity of 1300 tons per day may seem large, there are ample precedents for large scale biomass manipulation in a typical factory (sugar mill) for production of sugar. The usual first step in sugar production is to crush and squeeze sugar cane stems to release the sugar-rich plant juices. It is not unheard of for such sugar mills to squeeze 10,000 tons of cane per day during the peak of harvest. The desired product is the juice while the byproduct or waste is biomass bagasse in which the plant tissues have been reduced to centimeter size scale. The processing is achieved by a series of interconnected rollers which constitute a continuous flow operation. Sugar cane stalks are introduced at one end and cane juice and bagasse come out the other end.

However, conventional wisdom suggests that micropowder production would be much more time consuming because the plant material must be reduced not to centimeter scale pieces but to particles having a scale between 100 and 10 micrometers. The inventor has now discovered that a modification of the equipment traditionally used to process sugar cane can achieve micropowder production at a rapid rate and with a relatively modest input of energy. The process uses a series of rollers similar to those used in cane processing but the surface structure (grooves) of the rollers is different than that used to process cane. During the production of biomass by the roller system as the particle size is reduced, the moisture level of the biomass is also reduced. Starting with approximately 20%-50% moisture content for centimeter scale particles, the moisture level decreases to about 3-5% for particles in the several micrometer size range.

### BRIEF DESCRIPTION OF THE FIGURES

FIG. 1 is a diagram of an earlier biomass system based on mechanical disruption of air suspended particles.

FIG. 2 is a photographic representation of the tandem line “Squeezer” consisting of four pairs of rollers.

FIG. 3 is series of photographs showing the surface of the “Squeezer” rollers; FIG. 3A: 24 grooves; FIG. 3B: 40 grooves; FIG. 3C 47 grooves; and FIG. 3D 95 grooves.

FIG. 4 is drawing showing the terrace arrangement of three pairs of “Squasher” rollers.

FIG. 5 is photograph of the surfaces of a pair of “Squasher” rollers showing the shallow surface grooves.

FIG. 6 is a diagram of the overall process line.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a system for rapidly and efficiently reducing biomass to cellulosic micropowder.

The instant system replaces the inventor's own prior system shown in FIG. 1. In that system biomass chips 64 from a hopper were fed into a cutter 52 which reduced biomass to centimeter sized pieces 68. These were fed into a first rotary beater device 44 which kept the particles suspended. After many hours of operation the biomass was reduced to millimeter sized particles which were blown into a second mill 30 where they were suspended by propellers 35 and eventually reduced to particles in the submillimeters scale. These particles were fractionated with a baffle system to harvest the finished micropowder 60 in a container 42 while returning larger particles to the propellers 35 for additional treatment. While effective at making micropowder this system was slow (100-250 kg per hour or 2.5-5.0 tons per day), and necessarily consumed a considerable amount of energy to operate the mechanisms. The various grinding mills are generally operated by electric motors. The longer the process takes, the more energy is consumed by the motors. The faster the processing occurs, the less the overall energy consumption.

The present improved process system is inspired by the traditional cane mill where the sugar rich cell sap is rapidly extracted from chipped sugar cane by passing the plant material through the nap of large counter-rotating rollers not unlike a giant version of an old fashioned clothes wringer. The sugar cane is first chipped by a knife cutter to reduce the size of the pieces. The cane may also be crushed to breakdown the stem structure. Then this material is rapidly passed through a series of paired rollers to extract the juice. It is known in the art of sugar cane processing that there is a balance between speed and effectiveness of juice recovery. If plant material is fed into the series of rollers too rapidly, the thickness of material between the rollers will be too great. This thickness reduces the efficiency of juice recovery and having a greater number of rollers in series does not solve this problem because the plant material will be too thick at each successive roller pair. If the entering amount of sugar cane is reduced sufficiently, an layer of bagasse of optimal thickness will be formed between the rollers and essentially all the juice will be extracted by the series of in line rollers. Using a larger number of roller pairs will increase the effectiveness of extraction, to some degree, provided a critical thickness of the rolled material is not exceeded. Of course, there is no point in using a suboptimal amount of chipped sugar cane because this merely reduces the throughput and wastes operational energy.

Typical raw cellulosic biomass has appreciable moisture content—often around 50% by weight. Unlike juice in a sugar cane mill, the moisture is not the desired product of the operation; in fact, excess moisture can make processing into micropowder difficult. The new process uses a series of four paired rollers (tandem milling line), similar to sugar cane mill rollers, to reduce the moisture level of the biomass by “squeezing” the moisture out. Cellulosic biomass feedstock comes in a variety of forms with variable water content. For example, wood is processed by cutting it into small pieces (e.g. wood chips). Although water content varies with condition, wood often also has a water content of around 50% by weight.

Empty Oil Palm Fruit Bunches (EFB) are useful cellulosic biomass feedstock available in tropical regions. There are large plantations of Oil Palms (Elaeis guineensis) in Southeast Asia, particularly in Indonesia and Malaysia. These plantations produce Crude Palm Oil (CPO) from the fruits and seeds of the Oil Palm. The farmer harvests Fresh Fruit Bunches (FFB) from the palms. The FFB are heated and cooked by steam and then shaken to release the fruits which are pressed to produce CPO. The EFB are the cellulosic fruit branches left after the fruits are all removed. Although EFB are not “wood” in the botanical sense, they are fairly tough fibrous structures and have a typical 50% water content. The EFB are disrupted by a shredder to yield small fragments with a centimeter to millimeter size scale. Traditionally, this material is returned to the plantation to form mulch that adds organic material to the soil where it gradually decomposes. However, there is so much EFB added back to the plantation soil that adding EFB to the soil may actually result in environmental pollution.

In the inventive process the shredded EFB are treated by a squeezer roller train or line (FIG. 2). In the example, the rollers are constructed from cast iron and weigh about 110 kg each. The line contains four tandem (paired) grooved rollers (eight rollers total) as shown in FIG. 2. At each stage the plant material is squeezed between a pair of grooved rollers with each successive stage having a larger number of grooves. The rollers have a width of approximately 40 cm, and the preferred proportion is to have the roller diameter be about one half of the roller length. The first roller pair (FIG. 3A) has approximately 24 triangular (in cross-section) circumferentially disposed parallel grooves. The second roller pair (FIG. 3B) has approximately 40 triangular (55° apical angle) grooves while the third roller pair (FIG. 3C) has approximately 47 grooves and the fourth roller pair (FIG. 3D) has approximately 95 grooves. The grooves increase the effective surface area of the rollers as well as the area of the layer of squeezed plant material. In addition, when the plant material is pressed over the apices of the juxtaposed and interdigitated grooves, the resulting flexing of the material separates the cells at their junctures with each other (i.e., the middle lamella which glues adjacent plant cells together) and ultimately causes the cell walls themselves to pull apart to some degree. The successively smaller grooves encourage this process.

The first pair of rollers is operated by an 18 kW electric motor; the successive roller pairs are operated by 13.2 kW motors. Thus, the line consumes about 57.6 kW per hour to process about 12-20 tons of biomass so that the energy input is fairly modest. The “Squeezer” line reduces the water content to the 15-20% range while reducing the particle size into the millimeter or smaller size range. Much of the “squeezed” moisture actually drips from the rollers and can be captured and conducted away.

Next, the processed biomass enters the “Squasher” terrace line. This consists of three or four pairs of counter-rotating rollers arranged in a descending line as shown in FIG. 4. Each roller pair has a dedicated scraper plate to peel the appressed layer of biomass off the roller surface and to guide the biomass into the roller nap of the successive roller pair. As shown in FIG. 4 the surface of the Squasher rollers is essentially smooth with a series of shallow grooves (less than about 2 mm in depth) embossed into the surfaces. The Squasher roller breaks up the biomass structure by applying pressure. A thin layer of biomass is pressed between the two rollers so that there is efficient transfer of mechanical energy to the biomass structures thereby disrupting them. In addition, forcing the biomass into the shallow grooves helps hold the biomass in place (improving energy transfer) and also causes shear at an edge so that the biomass is cut in a way somewhat like the cutting forces operating within a pair of scissors. In addition, the shallow grooves encourage release of the biomass from the roller surface. At each level of the terrace, the scraper plate detaches and mixes the appressed biomass and supplies it to the next stage. As the biomass is processed by the Squasher, it is reduced to a maximum particle in the tens of micrometer size range with a large amount of material in the micrometer size range. Moisture level is reduced to 3-5% which results in considerable clumping and interaction of the micropowder due to static electricity. This can be controlled by a small water vapor or steam spray that discharges the static electricity.

The Squasher rollers are essentially smooth with only very shallow surface grooves which help ensure that crushed biomass can be readily removed from the rollers' surfaces. The axle and bearings of the upper roller of each pair are configured so that the roller can move in an upward or downward direction in response to the amount of biomass supplied to the roller. As the roller moves up and down, it adjusts to press the biomass tightly into a sheet partially adhering to the roller. The rollers rotate at a low speed usually in the range of 6-10 rpm. The overall capacity and effectiveness of the line depends on the roller size (surface area) and weight. An adjustable spring arrangement can be used to increase pressure over that supplied by the roller weight.

Finally, the micropowder exciting the Squasher line is fractionated and collected by a cyclone and bag filter combination. The cyclone uses centrifugal forces to remove the larger particles while the bag filter catches the small particles that have been adequately processed. Any particles that are too large can be recycled into the Squasher for additional processing. FIG. 5 shows a diagrammatic representation of the entire system. An optional air drying storage area is provided between the Squeezer and Squasher lines. In the storage area circulation of air and even heat application can be used to reduce the moisture level of the biomass as is necessary. Other well-known means for controlling the moisture level of the biomass (such as fluid bed drying and roll drying) can also be used. The micropowder exiting the terrace line Squasher is stored in a mixing container where an impeller stirs the powder to prevent clumping and ensure suspension of the micropowder in the air stream running into the cyclonic separator and the bag filter. Properly sized micropowder accumulates at the bag filter and is removed by being suspended in an air stream and can then be used either for direct combustion or for hydrolysis into sugars for making liquid fuels.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A process for efficiently and rapidly reducing the particle size and moisture content of cellulosic biomass comprising the steps of:
feeding centimeter scale cellulosic biomass pieces into a squeezer tandem roller line comprising a series of paired rollers having interdigitated surface grooves with successive roller pairs having a larger number of grooves thereby squeezing moisture from the biomass and reducing the squeezed biomass to millimeter scale particles;
conducting the squeezed biomass into a terraced squasher roller line comprising a series of paired rollers arranged so that the first roller pair is above the successive roller pair with the surfaces of the rollers being essentially smooth and with each roller pair having a scraper plate to scrape biomass material from the roller surface thereby reducing the squashed biomass into submillimeter scale particles; and
suspending the squashed biomass in an air stream which passes into a filter system which directs larger biomass particles back to the squasher roller line for additional processing and passes smaller micrometer scale particles as end product.

2. The process according to claim 1, wherein the squeezer roller line comprises four successive roller pairs.

3. The process according to claim 2, wherein the successive squeezer roller pairs have about 24 grooves, about 40 grooves, about 47 grooves and about 95 grooves, respectively.

4. The process according to claim 1, wherein the surfaces of the terraced squasher rollers are marked with shallow grooves with a depth less than about 2 mm.

5. The process according to claim 1, wherein the terraced squasher roller line comprises three sets of paired rollers.

6. The process according to claim 1, wherein the filter system comprises a cyclone filter and a bag filter.

7. The process according to claim 1 further comprising a step of drying the millimeter scale particles prior to the step of conducting the squeezed biomass into a terraced squasher roller line.
